(19) United States
(12) Patent Application Publication
(10) Pub. No.: US 2014/0172734 A1
(43) Pub. Date: Jun. 19, 2014

(54) SYSTEM AND METHOD FOR ITEM DELIVERY ON A SPECIFIED DATE

(71) Applicant: Arvinder K. Ginda, Rocklin, CA (US)

(72) Inventor: Arvinder K. Ginda, Rocklin, CA (US)

(21) Appl. No.: 13/715,886

(22) Filed: Dec. 14, 2012

(51) Int. Cl. G06Q 10/08

(52) U.S. Cl. CPC G06Q 10/083
USPC 705/330

(57) ABSTRACT

A system and method for item delivery on a specified date is disclosed. A particular embodiment includes; receiving from a sender a request for delivery of an item to a specified recipient, the request specifying delivery of either a virtual item or a tangible item; obtaining an identifier of the specified recipient, a specified recipient delivery location, and a specified delivery date; uploading, by use of a data processor, a virtual item and rendering the virtual item in a physical form, if the request specifics delivery of a virtual item; receiving delivery of a tangible item from the sender, if the request specifies delivery of a tangible item; and causing delivery of the item to the specified recipient on a date near the specified delivery date.

### TECHNICAL HELD

This patent application relates to computer-implemented software systems, according to one embodiment, and more specifically to providing an item delivery system.

### COPYRIGHT

A portion of the disclosure of this patent document contains material that is subject to copyright protection. The copyright owner has no objection to the facsimile reproduction of the patent document or the patent disclosure, as it appears in the Patent and Trademark Office patent files or records, but otherwise reserves all copyright rights whatsoever. The following notice applies to the software and data as described below and in the drawings that form a part of this document: Copyright 2011-2012 Arvinder K. Ginda, All Rights Reserved.

### BACKGROUND

It is sometimes desirable to have a package delivered on a specific date. For example, a sender of a package may want to have the package delivered on the date of an event (e.g., the recipient's birthday, an anniversary, etc.). For example, U.S. Pat. No. 6,929,181 describes a package delivery system that permits the sender to give a package to a carrier well before the desired delivery date. The carrier then stores the package and later delivers the package to the recipient on the date specified by the sender. In particular, the package delivery method involves receiving the package from the sender and having the sender identify the recipient and specify the date on which the package is to be delivered. The carrier then determines whether the sender's request is acceptable. The request is typically considered acceptable when the recipient's address is located within an acceptable delivery area and when the delivery date falls within an acceptable delivery date range. If the request is acceptable, the carrier takes custody of the package and stores the package until it is to be delivered. The package is finally delivered to the recipient on the sender specified delivery date.

However, conventional package delivery systems do not provide options for a sender to send any of a variety of items, which are delivered on a date and in a form specified by the sender.

### SUMMARY

In various example embodiments, the item delivery system of an example embodiment can be configured to deliver letters, documents, videos (e.g., received via upload or DVD), audio recordings (e.g., received via upload or CD), parcels, packages, gifts, or other virtual or tangible items (generally denoted herein as items) from a sender to a recipient at a specified date via a conventional delivery service, such as the United States Postal Service, FedEx, or UPS. Virtual items are items that can be transmitted via a computer and a network (e.g., template letters, electronic documents, uploaded videos or uploaded audio recordings (herein media items), or the like. The system provides a personal connection between two or more individuals by providing tangible items to be delivered by the item delivery system of an example embodiment when a sender is not in a position to send the item due to an expected or unexpected absence, special occasions, or just because. Individuals who receive tangible items from a sender will have a very strong emotional connection or reaction to the item delivered due to this service being so personal. Unlike the vast majority of social media available online and in modern culture, the item delivery system of an example embodiment is much more personal, because it is between individuals not to be viewed, shared or publicized with other people other than those specified by the sender. This is a very linear approach to connect people to one another by providing tangible items through the mail when otherwise delivery would not be possible due to an absence of the sender.

The item delivery system of an example embodiment not only applies to people who are going to be absent or delayed for an extended period of time. This type of service is very applicable to anybody who wants to take a moment and remember a special time in their life and share that moment with others. That moment to be shared would be sometime in the near or distant future depending on when the client/customer would want the message delivered.

The item delivery system of an example embodiment can be configured to deliver letters, documents, videos (e.g., received via upload or DVD), audio recordings (e.g., received via upload or CD), parcels, packages, gifts, or other virtual or tangible items from a sender to a recipient at a specified date via a conventional delivery service. In one embodiment of this system, the item delivery system provides an opportunity for the customer (sender) to write a letter, upload documents, or upload a video or audio recording (e.g., upload a message) and the message will be delivered sometime in the future on a date selected by the customer (sender). In another embodiment of this system, the item delivery system of an example embodiment allows the customer to create a letter, document, video, or other tangible item and provide the tangible item to the item delivery system of an example embodiment where the tangible item will be safely guarded and protected until delivered sometime in the future on a date selected by the customer (sender). The contents of the message or tangible item will not be reviewed by the item delivery system other than to confirm there is content within the tangible item so that it can be preserved and delivered at the specified date.

Often times, an individual thinks and wonders what they were thinking or feeling at a certain point in their life., only to be reminded later that they are not able to recall their exact thoughts or feelings due to the elapsed time. The item delivery system of an example embodiment gives the customer the opportunity to document or record their thoughts, so that their thoughts, ideas, feelings, and emotions can be delivered to themselves at a later date. Special times, like birthdays, graduations, anniversaries, engagements or any other special events can get lost in the moment. However, if one is able to stop for a brief moment and record or document their thoughts, this moment will last forever and will be recalled at any time, once at tangible item with a recorded thought has been turned over to the item delivery system of an example embodiment. The customer will be able to have the item delivered to themselves or another individual on the date of the customer's choosing. The letter, document, DVD, or the like will be tangible and delivered with a special touch from the item delivery system of an example embodiment ensuring a safe and secure delivery of the item via United States Post Service or another mail service carrier. The item can be kept forever and is something more than a virtual letter, email, virtual postcard other intangible item. The concept of having a tangible item, such as a letter or DVD from a loved one, creates a special connection between people that is often lost in translation in current societal atmosphere. Current trends in society lead individuals to connect using social media and rarely provide any tangible products, which can create a much stronger and needed bond between people. By utilizing the item delivery system of an example embodiment, the customer can have a very tangible item delivered to their loved one or themselves ensuring a memory that will last forever.

In one embodiment, these delivered items can be used for the following purposes:
Mother/Father/Grandparent/Family Member can write a letter to an unborn child describing how they feel waiting upon their arrival
Parent leaving on Tour of Duty/traveling for work with unknown return time (or if returning at all) to write letter to wife/children/family
A parent can record a hook on tape for their child and have a delivered during their absence.
Bride/Groom can record a message to one another on their wedding day/anniversaries and have the recorded message delivered on their next anniversary
Parents of bride/groom can record a message on the wedding day and have the recorded message delivered to the new couple on their anniversary
Bridal party/family members to bride/groom can record a message on the wedding day and have the recorded message delivered to the new couple on their next anniversary
Parents/Grandparents can write a letter to a child to be delivered on the child's graduation day
Business owner can write, birthday cards to clients/staff to be delivered on their specific birthday or anniversary
Terminally ill patient can write a letter or record a video to loved ones to be delivered after they are gone
Children to parents and relatives
Teacher to student
Write a letter to yourself with certain goals you plan to accomplish in a set time frame.
Siblings can have a message delivered to their sibling on a special date
A friend can write a letter or record a video to another friend and have the letter or video delivered sometime in the future.

In an example embodiment, a sender can send a virtual item or a tangible item. If the sender selects a virtual item, the sender can further select a document, a template, or a media item. The document as a virtual item can be an uploadable electronic copy of a document in a standard computer-readable format. A template can be a template letter, note, or message, which can be tilled in by the sender and uploaded to a server. The media item as a virtual item can be a photograph, image, graphic, animation, video, or audio file in a standard computer-readable format, which can be uploaded to a server. If the sender selects a tangible item, the sender can further provide a physical document, letter, message, note, photograph, image, graphic or the like in a paper or other physical form, or an animation, video, or audio on a DVD, CD, flash drive, or other form of physical storage media.

In an example embodiment, a sender can send a virtual item or a tangible item as a letter. The various embodiments enable letters to be used in a variety of ways, for example:
The customer can use the template provided or create blank document
These templates cover a wide range of relationships i.e. parent to child, child to parent, grandparent to grandchild, friend to friend, spouse to spouse, sibling to sibling, letter to self, etc.
Write a letter to a loved one sharing your thoughts, ideas, and emotional connection to that particular person.
Write a letter to yourself with certain goals you plan to accomplish in a set time frame.
Write a letter to your future soon to be born child, or pending adoption and have it set for deliver, at their first birthday, or a milestone birthday in the child's life. This letter could include some of your strengths and tears and moments of pride
Mother/Father/Grandparent/Family Member write letter to unborn child describing how they feel waiting upon their arrival
Parent leaving on Tour of Duty/traveling for work with unknown return time (or if returning at all) to write letter to wife/children/family
Bride/Groom to one another on wedding day/anniversaries
Parents of bride/groom on wedding day
Bridal party/family members to bride/groom on wedding day
Parents/Grandparents letter to child to be delivered on child's graduation day
Business owner writing, birthday cards to clients/staff to be delivered on their specific birthday or anniversary
Terminally ill patient letter to loved ones to be delivered after they are gone
Children to parents and relatives
Teacher to student

In an example embodiment, a sender can send a virtual item or a tangible item as a video. The various embodiments enable videos to be used in a variety of ways, for example:
Record a message to a loved one sharing your thoughts, ideas, and emotional connection to that particular person.
A parent can read child's favorite hook on video and have it delivered to the child during the parent's absence.
Record a message yourself with certain goals you plan to accomplish in a set time frame.
Record a message to your future soon to be horn child or pending adoption and have it set for deliver, at their first birthday, or a milestone birthday in the child's life. This message could include some of your strengths and fears and moments of pride Mother/Father/Grandparent/Family Member write letter to unborn child describing how they feel waiting upon their arrival
Parent leaving on Tour of Duty/traveling friar work with unknown return time (or if returning at all) can record a message to wife/children/family
Bride/Groom to one another on wedding day anniversaries
Parents of bride/groom on wedding day
Bridal party/family members to bride/groom on wedding day
Parents/Grandparents letter to child to be delivered on child's graduation day
Business owner writing birthday cards to clients/staff to be delivered on their specific birthday or anniversary
Terminally ill patients can record video message to loved ones to be delivered after they are gone
Children to parents and relatives
Teacher to student

In an example embodiment, a sender can send a tangible item, such as a physical document, letter, message, note, photograph, image, graphic or the like in a paper or other physical form, or an animation, video, or audio on a DVD, CD, flash drive, or other form of physical storage media. The various embodiments enable tangible items to be delivered in a variety of ways. For example, the item delivery system of an example embodiment can provide a physical mailing address to customers, wherein the address can be listed on a website. This physical address can allow customers or clients to send a physical package to the item delivery system of an example embodiment to hold onto and to deliver the physical package on a date selected by the customer. The package must not contain any illegal substances, weapons, drugs of any kind, liquids, or any other perishable items. The package size, weight and length of time to be secured by the item delivery system can affect the price the customer will be charged. Therefore, any packages to be retained by the item delivery system for any extended period of time can vary in maintenance charges to the customer. These packages do not typically include any virtual items, such as letters, video or documents submitted via the website associated with the item delivery system of an example embodiment.

Upon receiving a physical package from a customer for delivery, each package can be marked and coded. Each package can receive its own tracking number which can identify the sender, recipient, date of reception, date of delivery and a brief description of the contents. Each package can be marked properly and secured safely at an undisclosed area strictly controlled by the item delivery system of an example embodiment. Once a future delivery date is identified for a particular item, the item delivery system can send an email, text message, or the like, and daily reminder to the delivery team to prepare the package for delivery. The delivery team can retrieve the item and have it prepared for delivery. The item can be placed in regular mail several days prior to the actual delivery date to ensure a timely delivery.

An additional service of the item delivery system of an example embodiment can be provided for companies, families or individuals where they can have a special birthday card delivered by the item delivery system of an example embodiment with a special touch and to special message. The customer can request to have birthday cards or letters delivered to the other parties or employees on their birthday.

The item delivery system of an example embodiment can also provide a set of administrative services to enable a site owner(s) or administrator to operate the website associated with the item delivery system. The site owner(s) can handle all content that is received via website, regular mail or any other form of delivery. The contents of the letters, videos, DVD's or packages are not reviewed by the site administrators, other than to confirm that there is content that exists in the letter or videos and that the content does not violate any site policies. The letters and videos can be uploaded onto an existing server of the site. However, an additional copy can be kept on an external hard drive as a backup in case the server is not accessible or if the server malfunctions. The content can be printed (for letters) or burned onto DVD's several days prior to the actual delivery of the package, letter or DVD to the recipient. Upon delivery of the item, the content that is left can be archived.

A special database can be created to document each letter, video, document or package that is received by the item delivery system of an example embodiment. This database can include the following information, which can identify the sender, recipient, date of reception, date of delivery, and a brief description of the contents. This database can constantly update as new items are received. Once a future delivery date is identified for a particular item, the item delivery system can send an email, text message, or the like, and daily reminder to the delivery team to prepare the package for delivery. The delivery team can retrieve the item and have it prepared for delivery. The item can be placed in regular mail several days prior to the actual delivery date to ensure a timely delivery.

Prior to completing a transaction for a letter, document, video, or other item, the customer can acknowledge that items will not be delivered on Sundays, holidays or any other days the United States Postal Service is inactive. This acknowledgement can also include acts of God, i.e. weather, acts of terror, or any other unforeseen circumstances. The item delivery system of various example embodiments is described in more detail below.

### BRIEF DESCRIPTION OF THE DRAWINGS

The various embodiments is illustrated by way of example, and not by way of limitation, in the figures of the accompanying drawings in which;

FIG. 1 illustrates an example embodiment of a system for item delivery on a specified date;

FIG. 2 illustrates a detail of the processing flow used in an example embodiment;

FIG. 3 illustrates a detail of the databases used in an example embodiment;

FIGS. 4 through 9 illustrate example user interface screen snapshots of example embodiments:

FIG. 10 illustrates another example embodiment of a networked system in which various embodiments may operate;

FIG. 11 is a processing flow chart illustrating an example embodiment of an item delivery method as described herein; and

FIG. 12 shows a diagrammatic representation of machine in the example form of a computer system within which a set of instructions when executed may cause the machine to perform any one or more of the methodologies discussed herein.

### DETAILED DESCRIPTION

In the following description, for purposes of explanation, numerous specific details are set forth in order to provide a thorough understanding of the various embodiments. It will be evident, however, to one of ordinary skill in the art that the various embodiments may be practiced without these specific details.

In the various embodiments described herein, a system and method for item delivery on a specified date is disclosed. In various embodiments, a software application program is used to enable the composition and delivery of an item using a computer system. As described in more detail below, the computer or computing system on which the described embodiments can be implemented can include personal computers (PCs), portable computing devices, laptops, tablet computers, personal digital assistants (PDAs), personal communication devices (e.g., cellular telephones, smartphones, or other wireless devices), network computers, set-top boxes, consumer electronic devices, or any other type of computing, data processing, communication, networking, or electronic system.

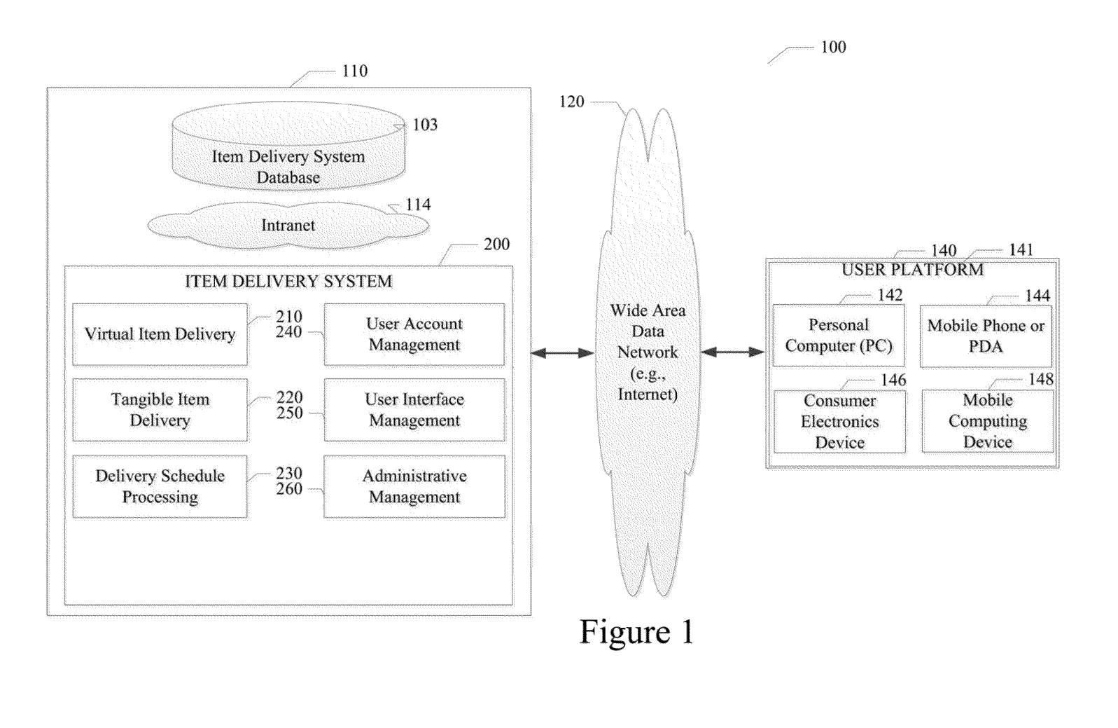

Referring now to FIG. 1, in an example embodiment, a system for item delivery on a specified date is disclosed. In various example embodiments, an application or service, typically provided by or operating on a host site (e,g., a website) 110, is provided to simplify and facilitate the downloading or hosted use of the item delivery system 200 of an example embodiment. In a particular embodiment, the item delivery system 200 can be downloaded from the host site 110 by a user at a user platform 140. Alternatively, the item delivery system 200 can be hosted by the host site 110 for a networked user at a user platform 140. The details of the item delivery system 200 of an example embodiment are provided below.

Referring again to FIG. 1, the item delivery system 200 can be in network communication with a plurality of user platforms 140. The host site 110 and user platforms 140 may communicate and transfer data and information in the data network ecosystem 100 shown in FIG. 1 via a wide area data network (e,g., the Internet) 120. Various components of the host site 110 can also communicate internally via a conventional intranet or local area network (LAN) 114.

Networks 120 and 114 are configured to couple one computing device with another computing device. Networks 120 and 114 may be enabled to employ any firm of computer readable media for communicating information from one electronic device to another. Network 120 can include the Internet in addition to LAN 114, wide area networks (WANs), direct connections, such as through a universal serial bus (USB) port, other forms of computer-readable media, or any combination thereof. On an interconnected set of LANs, including those based on differing architectures and protocols, a router and/or gateway device acts as a link between LANs, enabling messages to be sent between computing devices. Also, communication links within LANs typically include twisted wire pair or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), wireless links including satellite links, or other communication links known to those of ordinary skill in the art. Furthermore, remote computers and other related electronic devices can be remotely connected to either LANs or WANs via a wireless link, WiFi, Bluetooth, satellite, or modem and temporary telephone link.

Networks 120 and 114 may further include any of a variety of wireless sub-networks that may thriller overlay stand-alone ad-hoc networks, and the like, to provide an infrastructure-oriented connection. Such sub-networks may include mesh networks, Wireless LAN (WLAN) networks, cellular networks, and the like. Networks 120 and 114 may also include an autonomous system of terminals, gateways, routers, and the like connected by wireless radio links or wireless transceivers. These connectors may be configured to move freely and randomly and organize themselves arbitrarily, such that the topology of networks 120 and 114 may change rapidly and arbitrarily.

Networks 120 and 114 may further employ a plurality of access technologies including 2nd (2G), 2.5, 3rd (3G), 4th (4G) generation radio access for cellular systems, WLAN, Wireless Router (WR) mesh, and the like. Access technologies such as 2G, 3G, 4G, and flame access networks may enable wide area coverage for mobile devices, such as one or more of client devices 141, with various degrees of mobility. For example, networks 120 and 114 may enable a radio connection through a radio network access such as Global System for Mobile communication (GSM), General Packet Radio Services (GPRS), Enhanced Data GSM Environment (EDGE), Wideband Code Division Multiple Access (WCDMA), CDMA2000, and the like. Networks 120 and 114 may also be constructed for use with various other wired and wireless communication protocols, including TCP/IP, UDP, SIP, SMS, RTP, WAP, CDMA, TDMA, EDGE, UMTS, GPRS, GSM, UWB, WiFi, WiMax, IEEE 802.11x, and the like. In essence, networks 120 and 114 may include virtually any wired and/or wireless communication mechanisms by which information may travel between one computing device and another computing device, network, and the like. In one embodiment, network 114 may represent a LAN that is configured behind a firewall (not shown), within a business data center, for example.

The virtual items configured for delivery can be an form of network transportable digital data. The network transportable digital data can be transported in any of a family of file formats and associated mechanisms usable to enable a host site 110 and a user platform 140 to transfer data over a network 120. In one embodiment, the file format can be a MICROSOFT™ Word format (MSWord) or a simple text file format (.txt) however, the various embodiments are not so limited, and other file formats and transport protocols may be used. For example, data formats other than MS Word, .txt formats, or open/standard formats can be supported by various embodiments. Any electronic file format, such as Microsoft Access Database Format (MDB). Portable Document Format (PDF), audio (e.g., Motion Picture Experts Group Audio Layer 313 MP3, and the like), video (e.g., MP4, and the like), and any proprietary interchange format defined by specific sites can be supported by the various embodiments described herein.

In a particular embodiment, a user platform 140 with one or more client devices 141 enables a user to access data and provide data for the item delivery system 200 via the host 110 and network 120. Client devices 141 may include virtually any computing device that is configured to send and receive information over a network, such as network 120. Such client devices 141 may include portable devices 144, such as, cellular telephones, smart phones, display pagers, radio frequency (RE) devices, infrared (IR) devices, global positioning devices (GPS), Personal Digital Assistants (PDAs), handheld computers, wearable computers, tablet computers, integrated devices combining one or more of the preceding devices, and the like. Client devices 141 may also include other computing devices, such as personal computers 142, multiprocessor systems, microprocessor-based or programmable consumer electronics, network PC's, and the like. Client devices 141 may also include other processing devices, such as consumer electronic (CE) devices 146 and/or mobile computing devices 148, which are known to those of ordinary skill in the art. As such, client devices 141 may range widely in terms of capabilities and features. For example, a client device configured as a cell phone may have a numeric keypad and a few lines of monochrome LCD display on which only text may be displayed. In another example, a web-enabled client device may have a touch sensitive screen, a stylus, and several lines of color LCD display in which both text and graphics may be displayed. Moreover, the web-enabled client device may include a browser application enabled to receive and to send wireless application protocol messages (WAP), and/or wired application messages, and the like. In one embodiment, the browser application is enabled to employ HyperText Markup Language (HTML), Dynamic HTML, Handheld Device Markup Language (HDML), Wireless Markup Language (WML), WMLScript, JavaScript, EXtensible HTML (xHTML), Compact HTML (CHTML), and the like, to display and/or send digital information. In other embodiments, mobile devices can be configured with applications (apps) with which the functionality described herein can be implemented.

Client devices 141 may also include at least one client application that is configured to send and receive item data or/or control data from another computing device via a wired or wireless network transmission. The client application may include a capability to provide and receive textual data, graphical data, video data, audio data, and the like. Moreover, client devices 141 may be further configured to communicate and/or receive a message, such as through a Short Message Service (SIMS), direct messaging (e.g., Twitter), email, Multimedia Message Service (MMS), instant messaging (IM), internet relay chat (IRC), mIRC, Jabber, Enhanced Messaging Service (EMS), text messaging, Smart Messaging, Over the Air (OTA) messaging, or the like, between another computing device, and the like.

As one option, the item delivery system 200, or a portion thereof, can be downloaded to a user device 141 of user platform 140 and executed locally on a user device 141. The downloading of the item delivery system 200 application can be accomplished using conventional software downloading functionality. As a second option, the item delivery system 200 can be hosted by the host site 110 and executed remotely, from the user's perspective, on host system 110. In one embodiment, the item delivery system 200 can be implemented as a service in a service oriented architecture (SOA). In any case, the functionality performed by the item delivery system 200 is as described herein, whether the application is executed locally or remotely, relative to the user.

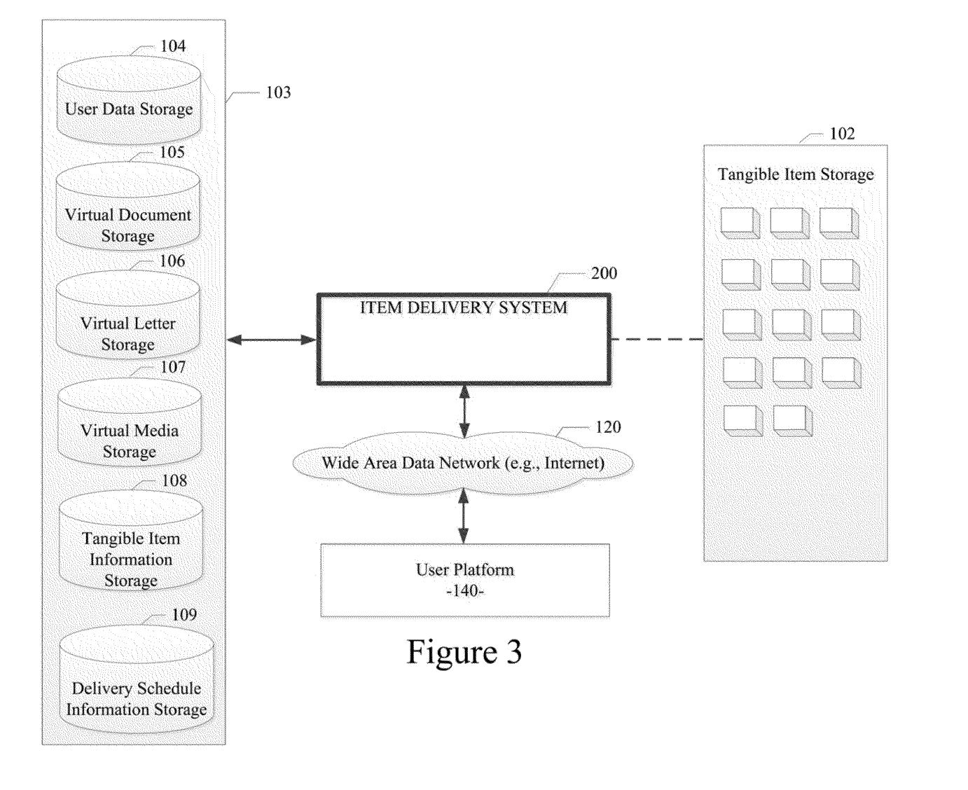

Referring again to FIG. 1, the item delivery system 200 of an example embodiment is shown to include an item delivery system database 103. The database 103 is used in an example embodiment for data storage of information related to the items being delivered, the users involved in the deliveries, and the schedule for deliveries. The components of database 103 are illustrated for an example embodiment in FIG. 3 and described in more detail below.

Referring again to FIG. 1, host site 110 of an example embodiment is shown to include an item delivery system 200. Item delivery system 200 can include a virtual item delivery module 210, a tangible item delivery module 220, a delivery schedule processing module 230, a user account management module 240, a user interface management module 250, and an administrative management module 260. Each of these modules can be implemented as software components executing within an executable environment of item delivery system 200 operating on host site 110 or user platform 140. Each of these modules of an example embodiment is described in more detail below in connection with the figures provided herein.

Referring to FIG. 1, the item delivery system 200 of an example embodiment can include a virtual item delivery module 210. The virtual item delivery module 210 is responsible for the intake of a virtual item for delivery. As described above, a virtual item is an item that can be transmitted via a computer and a network (e.g., template letters, electronic documents, uploaded videos or uploaded audio recordings (herein media items), or the like. The document as a virtual item can be an uploadable electronic copy of a document in a standard computer-readable format. A template can be a template letter, note, or message, which can be filled in by the sender and uploaded to a server. The media item as a virtual item can be a photograph, image, graphic, animation, video, or audio file in a standard computer-readable format, which can be uploaded to a server.

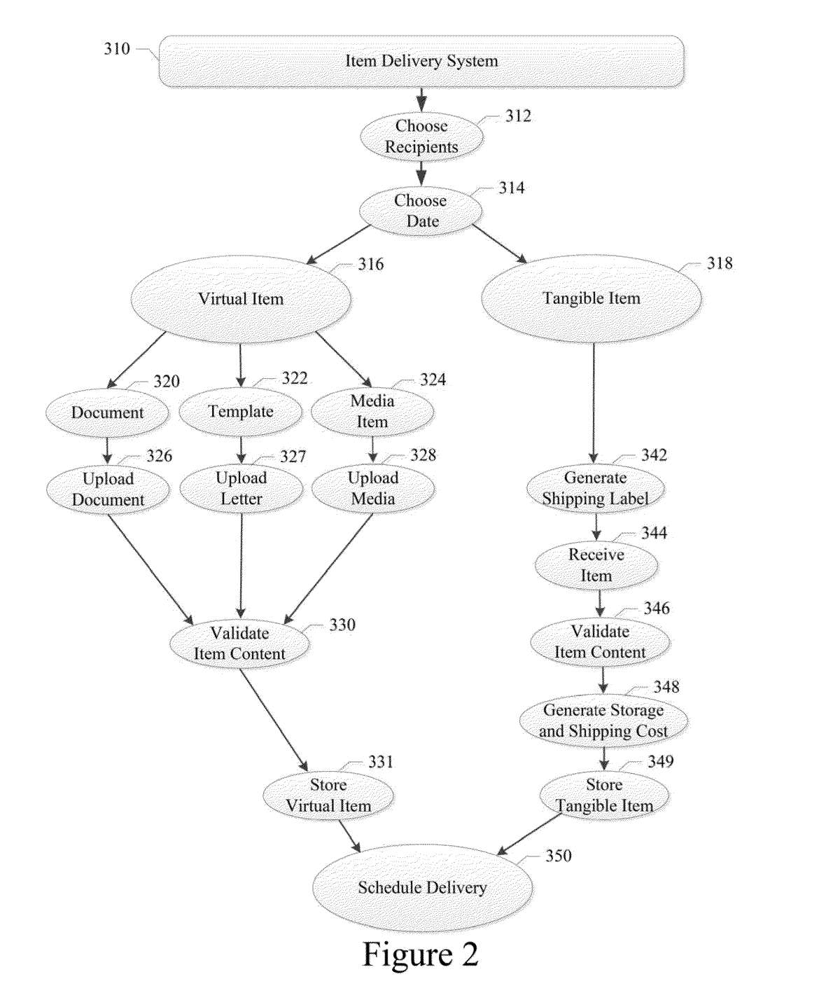

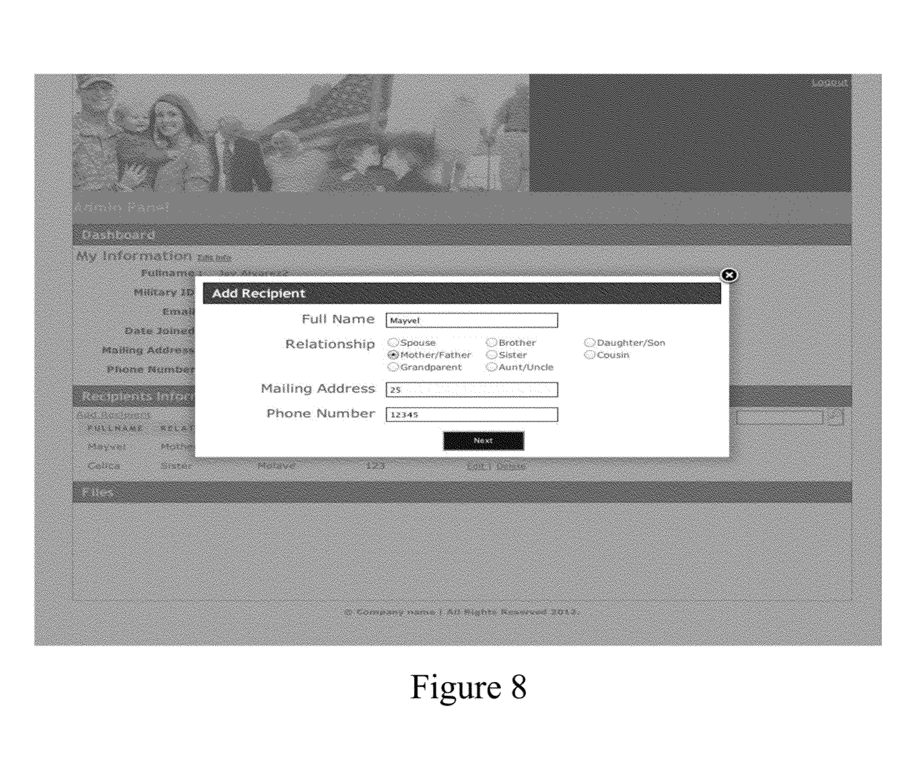

Referring, now to FIG. 2, a detail of the processing flow used in an example embodiment is illustrated. As shown, the item delivery system 200 of an example embodiment uses a user interface component 310 to prompt a user/sender to choose an item recipient in processing object 312. The user interface component 310 and related prompts can be provided as part of the user interface management module 250 described in more detail below. In processing object 312, the user can select from any of a plurality of recipients in a contact list, address book, or via a direct entry of a name and a delivery address corresponding to the name. The selected or entered recipient can be anyone with an address to which a physical item can be delivered. A sample user interface display screen for enabling a user to specify a delivery recipient is shown in FIG. 8.

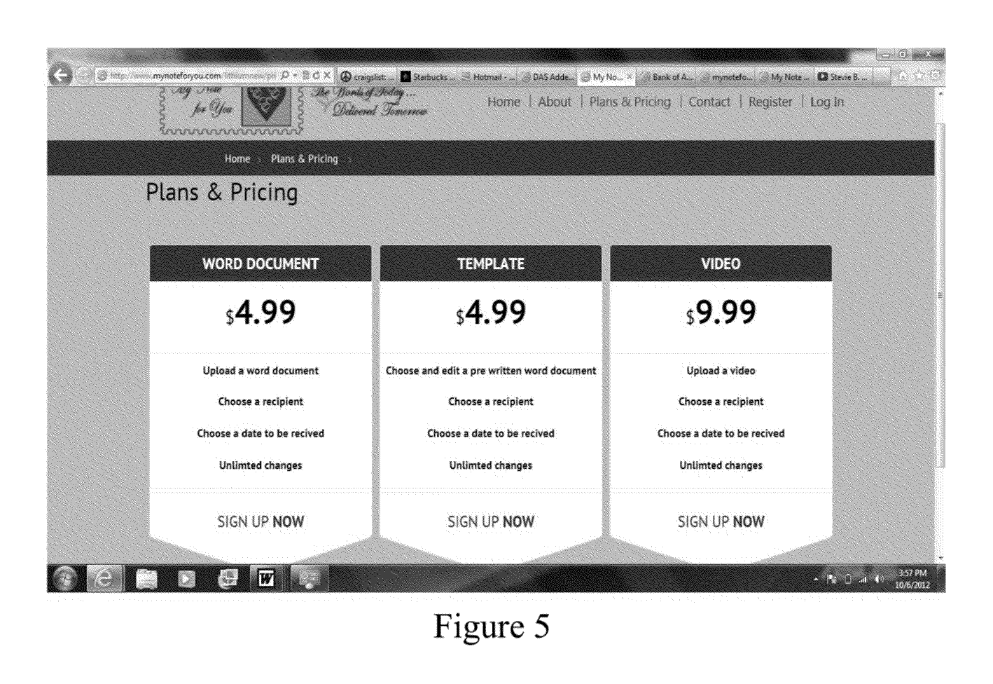

The item delivery system 200 of an example embodiment can also use the user interface component 310 to prompt a user/sender to choose a delivery date in processing object 314. The delivery date can be any future date or date range. The item delivery system 200 of an example embodiment can also use the user interface component 310 to prompt a user/sender to choose a virtual item for delivery or a tangible item for delivery. If the user chooses a virtual item for delivery, processing object 316 is processed and the virtual item delivery module 210 is activated. At processing object 316, the virtual item delivery module 210 prompts the user/sender to choose from among a plurality of various types of virtual items. The user interface prompts provided by the virtual item delivery module 210 can be provided as part of the user interface management module 250 described in more detail below. In processing object 316 of an example embodiment, the virtual item delivery module 210 prompts the user/sender to choose an electronic document, a template letter, or media item option. FIG. 5 illustrates an example user interface display screen for prompting a user/sender to choose a virtual item. The chosen option represents the type of virtual item the user/sender wants to have delivered to the chosen recipient on the specified date.

If the user/sender chooses the electronic document option, processing object 320 is activated to prompt the user to specify a location of the document and/or an identifier of the specified document. The document can be any form of computer transportable document the user/sender wishes to have delivered to the specified recipient. The location of the specified document should be a location that is accessible to a computing device, which can cause the uploading of the specified document to a computing device accessible to the host computer 110. Typically, the uploading of the specified document is performed between a device of the user platform 140 and the host computer 110 via network 120. The specified document is uploaded to the host computer 110 in processing object 326. The specified document can be stored in virtual document storage 105 shown in FIG. 3.

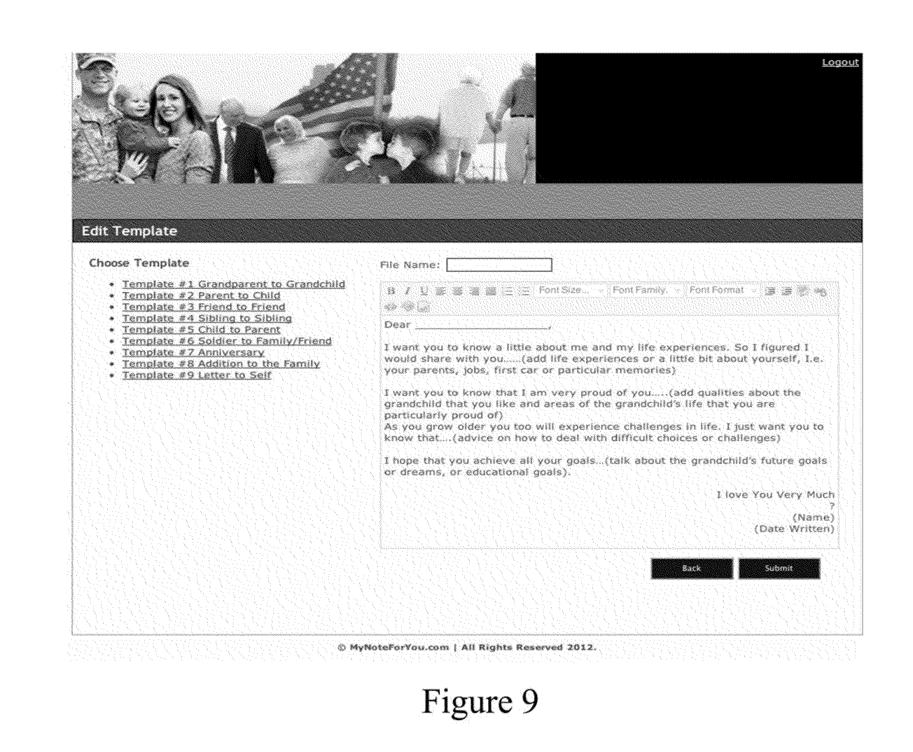

If, at processing object 316, the user/sender chooses the template letter option, processing object 322 is activated, to prompt the user with a series of user interface display screens for creation of template letter, FIG. 3 illustrates an example user interface display screen for prompting a user/sender to create a template letter. The templates can guide a user/sender in writing a letter for various types of recipients. As shown in FIG. 9, the user/sender can be prompted to select from among a plurality of letter template options. The various embodiments enable letters, and their associated templates, to be used in a variety of ways, for example:
The customer can use one of the templates provided or create blank document.
The templates cover a wide range of relationships, e.g., parent to child, child to parent, grandparent to grandchild, friend to friend, spouse to spouse, sibling to sibling, letter to self, etc.
The templates can guide a user/sender in writing a letter to a loved one sharing their thoughts, ideas, and emotional connection to that particular person.
The templates can guide a user/sender in writing a letter to one's self with certain goals the individual plans to accomplish in a set time frame.
The templates can guide a user/sender in writing a letter to their future soon-to-be-born child or pending adoption and have it set for delivery at their first birthday, or a milestone birthday in the child's life. This letter could include some of the individual's strengths and fears and moments of pride. Mother/Father/Grandparent/Family Member can write a letter to an unborn child describing how they feel waiting upon their arrival.
Parent leaving on Tour of Duty/traveling for work with unknown return if returning at all) can write a letter to the wife/children/family.
Bride/Groom can write a letter to one another on their wedding day/anniversaries.
Parents of bride/groom can write a letter on the wedding day.
Bridal party/family members to bride/groom can write a letter on the wedding day.
Parents/Grandparents can write a letter to a child to be delivered on the child's graduation day.
Business owner can write birthday cards to clients/staff to be delivered on their specific birthday or anniversary.
Terminally ill patient can write a letter to loved ones to be deliver after they are gone.
Children can write a letter to parents and relatives.
Teacher can write a letter to a student.

Once the user/sender completes the letter, the composed letter can be uploaded to the item delivery system 200. Typically, the uploading of the composed letter is performed between a device of the user platform 140 and the host computer 110 via network 120. The composed letter is uploaded to the host computer 110 in processing object 327. The composed letter can he stored in virtual letter storage 106 shown in FIG. 3.

If the user/sender chooses the media item option, processing object 324 is activated to prompt the user to specify a location of the media item and/or an identifier of the specified media item. The media item can be any form of computer transportable media item the user/sender wishes to have delivered to the specified recipient. The location of the specified media item should be a location that is accessible to a computing device, which can cause the uploading of the specified media item to a computing device accessible to the host computer 110. The various embodiments enable media items to be used in a variety of ways, for example:
The user/sender can record a message to a loved one sharing his/her thoughts, ideas, and optional connection to that particular person.
A parent can read child's favorite hook on video and have it delivered to the child during the parent's absence.
The user/sender can record a message him/herself with certain goals s/he plans to accomplish in a set time frame.
The user/sender can record a message to their future soon-to-be-born child or pending adoption and have it set for delivery at their first birthday, or as milestone birthday in the child's life. This message could include some of the individual's strengths and fears and moments of pride. Mother/Father/Grandparent/Family Member can record a video or audio recording for an unborn child describing how they feel waiting upon their arrival.
Parent leaving on Tour of Duty/traveling for work with unknown return time (or if returning at all) can record a message to the wife/children/family,
Bride/Groom can record a message to one another on their wedding day/anniversaries.
Parents of bride groom can record a message on the wedding day,
Bridal party/family members can record a message to the bride/groom on the wedding day.
Parents/Grandparents can record as message to a child to be delivered on child's graduation day.
Business owner can record a message in birthday cards to clients staff to be delivered on their specific birthday or anniversary.
Terminally ill patients can record a video message to loved ones to be delivered after they are gone.
Children can record as message to parents and relatives.
Teacher can record a message to a student.

Once the user/sender specifies the location and/or identity of the media item, the media item can be uploaded to the item delivery system 200. Typically, the uploading of the media item is performed between a device of the user platform 140 and the host computer 110 via network 120. The media item is uploaded to the host computer 110 in processing object 328. The media item can be stored in virtual media storage 107 shown in FIG. 3.

Once the document, template letter, or media item (e.g., virtual item) is uploaded to the item delivery system 200 as described above, the content of the virtual item is validated in processing object 330. For example, the virtual item is checked for either null content or a content length greater than a pre-configured maximum. In a particular embodiment, the virtual item can also be checked for viruses or other malware. In a particular embodiment, the virtual item can also be checked for conformity with policies of the host site 110. For example, the content of the virtual item can also be checked for obscene or illegal content. In a particular embodiment, the virtual item can be digitally compressed to decrease the size of the virtual item. The virtual item can also be encrypted for security. The virtual item is also tagged with the name/user identity of the sender, the name/identity of the recipient, the delivery location, and the delivery date. Upon suceessful validation, the virtual item can be passed to the processing object 331, which stores the virtual item in database 103. The schedule delivery processing, object 350 is then activated for delivery scheduling. The schedule delivery processing is described in more detail below. If the validation of the virtual item fails at processing object 330, the user/sender is notified with an error message.

Referring again to FIG. 1, the item delivery system 200 of an example embodiment is shown to include a tangible item delivery module 220. The tangible item delivery module 220 is responsible for the intake of a tangible item for delivery. As described above, a tangible item is a physical item that typically cannot be transmitted via a computer and a network. For example, tangible items can include: physical letters (e.g., printed), physical documents (e.g., printed), DVD videos, CD audio recordings, parcels, packages, gills, or other tangible items from a sender. The intake of as tangible item for delivery includes providing a means for prompting the user/sender to send the tangible item to an agent of the item delivery system 200 for safe storage until the delivery to the recipient can be effected.

Referring again to FIG. 2, the detail of the processing flow used in an example embodiment is illustrated. As shown and described above, the item delivery system 200 of an example embodiment uses the user interface component 310 to prompt a user/sender to choose an item recipient in processing object 312 and a delivery date in processing object 314. The item delivery system 200 of an example embodiment can also use the user interface component 310 to prompt a user/sender to choose a tangible item for delivery. If the user chooses a tangible item for delivery, processing object 318 is processed and the tangible item delivery module 220 is activated. At processing object 318, the tangible item delivery module 220 prompts the user/sender for information related to the tangible item. The tangible item delivery module 220 also informs the user/sender how to send the tangible item to the agent of the item delivery system 200. The user interface prompts provided by the tangible item delivery module 220 can be provided as part of the user interface management module 250 described in more detail below. In processing object 318 of an example embodiment, the tangible item delivery module 220 prompts the user/sender to provide any additional information necessary to generate a shipping label for the tangible item. This information may include the name of the recipient or a receiving agent for the recipient, a delivery address, special delivery instructions, preferred shipper, insurance preferences, and the like. A shipping label for the tangible item can he generated by the processing object 342. The shipping label can be in a printed or an electronic form. In processing block 344, the tangible item delivery module 220 can inform the user/sender how to send the tangible item to the agent of the item delivery system 200. Typically the user/sender can box the tangible item, apply the generated shipping label, and use a conventional shipper to send the tangible item to the agent of the item delivery system 200. The processing object 344 can be used to track the delivery and receipt of the tangible item shipped from the user/sender to the agent of the item delivery system 200.

Upon receipt of the tangible item, the content of the tangible item is validated in processing object 346. For example, the tangible item is checked for either null content or a content size or weight greater than a pre-configured maximum. In a particular embodiment, the tangible item can also be checked for explosives, flammables, toxic content, and the like. The tangible item must not, contain any illegal substances, weapons, drugs of any kind, liquids, or any other perishable items. The package size, weight and length of time to be secured by the item delivery system can affect the price the customer will be charged. Therefore, any packages to be retained by the item delivery system for any extended period of time can vary in maintenance charges to the customer. In a particular embodiment, the tangible item can also be checked for conformity with policies of the host site 110. For example, the content of the tangible item can also be checked for obscene or illegal content. In a particular embodiment, the tangible item can be re-packaged to protect the contents. The virtual item can also be transferred to a locked facility for security. The virtual item is also tagged with the name/user identity of the sender, the name/identity of the recipient, the delivery location, and the delivery date. If the validation of the tangible item fails at processing object 346, the user/sender is notified with a message and the tangible item can be returned to the user/sender.

Upon successful validation, the tangible item or information related thereto, can be passed to the processing object 348, which generates a storage quote for storage of the tangible item until delivery and a shipping quote for costs to deliver the tangible item to the recipient. The storage and shipping quotes are sent to the user/sender in a notification via any conventional means. Each tangible item can also be marked and coded. Each tangible item can receive its own tracking number which can identify the sender, recipient, date of reception, date of delivery and as brief description of the contents.

Once the user/sender is notified of the storage and shipping costs by the processing object 348, the tangible item is stored in a secure storage area 102, represented in FIG. 3, by use of the processing object 349 and an agent of the item delivery system 200. The storage area can be a locked facility under control of the item delivery system 200 or an agent thereof. Information related to the tangible item can be stored in tangible item information storage 108 shown in FIG. 3. After arranging storage of the tangible item, the schedule delivery processing object 350 is then activated for delivery scheduling. The schedule delivery processing is described in more detail next.

Referring again to FIG. 1, the item delivery system 200 of an example embodiment is shown to include a delivery schedule processing module 230. The delivery schedule processing module 230 is responsible for managing the coordination of item deliveries to the specified recipients on the specified dates. As described above and shown in FIG. 2, a virtual item or a tangible item can be processed and information related to the item can be provided to the schedule delivery processing object 350. The schedule delivery processing object 350 can be implemented by the delivery schedule processing module 230. The delivery schedule processing module 230 generates a schedule of item deliveries. As items are received via the item delivery system 200, the delivery schedule processing module 230 adds a record corresponding to the item to the delivery schedule. The record can be added in date order or the delivery schedule can be re-sorted in date order once a new record is added. Each record can include an identifier and/or location of the item for delivery, an identifier of the sender, an identifier of the recipient, the delivery address, and the delivery date. The sorted delivery schedule can be stored in the database 109 shown in FIG. 3. An administrator or agent for the item delivery system 200 of an example embodiment can use the sorted delivery schedule to queue and marshal items for delivery on the dates specified by the sender. On or near the delivery date for particular items, virtual items for delivery can be rendered in a physical form. For example, electronic documents and template letters can be printed, videos and audio recordings can be burned to optical, magnetic, or semiconductor media. Tangible items can be retrieved from the tangible item storage area 102. The items can be prepared for mailing or shipping using standard the U.S. Post Office or other parcel delivery services, mail carriers, or shipping carriers, such as FedEx or UPS. Mailing/shipping labels can be printed using the sender and recipient addresses. The items can then be dispatched to the mail or shipping service using, standard means. As a result, the virtual or tangible items can be delivered to the recipient specified by the sender on the date or near the date (e.g., within one day) specified by the sender.

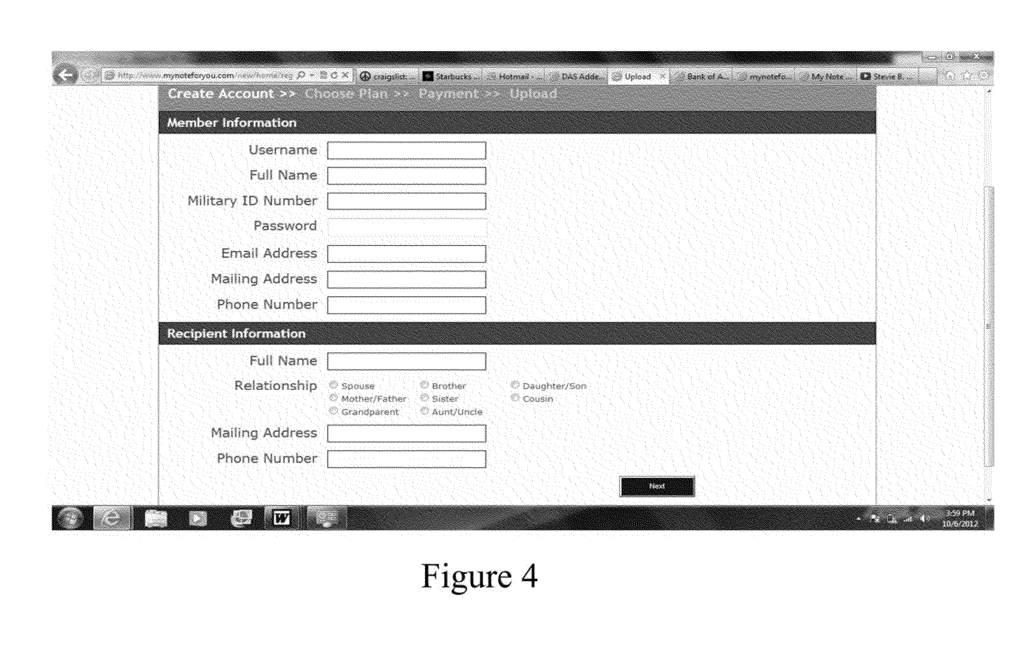

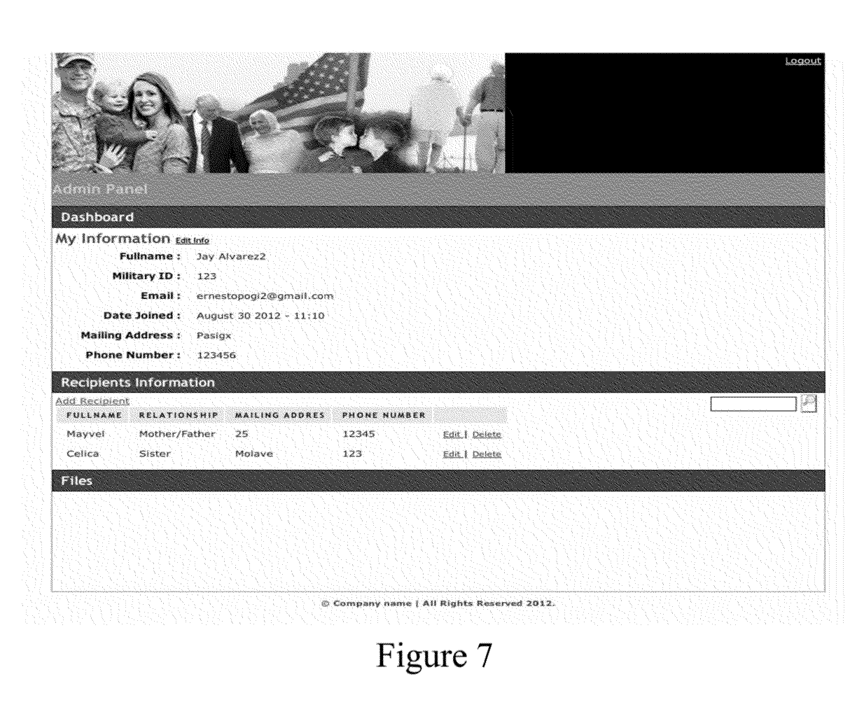

Referring again to FIG. 1, the item delivery system 200 of an example embodiment is shown to include a user account management module 240. The user account management module 240 can be used to create and maintain a user account on the host site 110. The user account management module 240 can also be used to configure user settings, create and maintain a user/user profile on host site 110, and otherwise manage user data and operational parameters on host site 110. A sample user interface display screen for enabling, a user to create a user account is shown in FIG. 4. The user data and operational parameters can be retained in database 104 shown in FIG. 3. A sample user interface display screen for enabling a user to view information related to a user account is shown in FIG. 7.

Referring again to FIG. 1, the item delivery system 200 of an example embodiment is shown to include a user interface management module 250. The user interface management module 250 handles the presentation of various user interface displays, display screens, windows, frames, or the like. In an alternative embodiment, the user interface can be implemented as a series of web pages. In another alternative embodiment, the user interface can be implemented as a series display screens on a mobile device as implemented by a mobile application or app. In yet another alternative embodiment, the user interface can be implemented as a series of voice command/responses implemented using conventional voice recognition and voice synthesis technology on a mobile device as implemented by a mobile application or app. These various user interface displays are provided to present information and item images to a user of the item delivery system 200 of an example embodiment. The user interface management module 250 also receives user inputs and configures the various user interface displays in conformity with the user inputs, command selections, and the like.

Although the various user interface displays provided by the user interface management module 250 are nearly infinitely varied, several sample user interface sequences are provided herein and in the corresponding figures to describe various features of the disclosed embodiments. These sample user interface displays and sequences are described above.

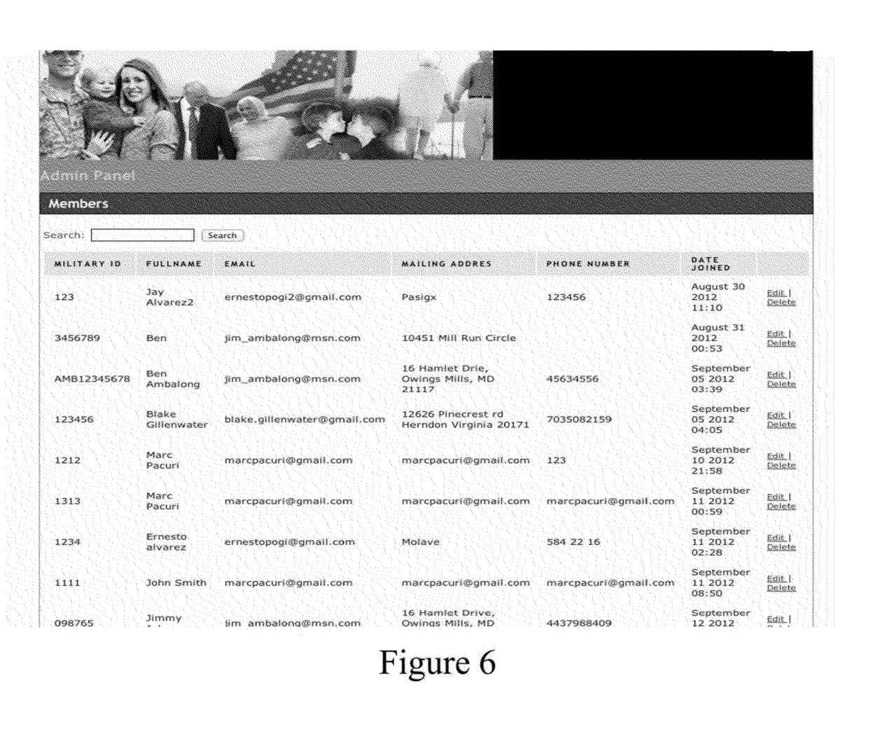

Referring again to FIG. 1, the item delivery system 200 of an example embodiment is shown to include an administrative management module 260. The administrative management module 260 can be used by an agent of the item delivery system 200 to manage user accounts and to manage the intake and delivery of items for delivery. For example, the administrative management module 260 can be used to generate the information panel shown in FIG. 6, which lists information for a plurality of user accounts.

FIG. 3 illustrates a detail of the databases used in an example embodiment. As shown, database 103 can include user data storage 104, virtual document storage 105, virtual letter storage 106, virtual media storage 107, tangible item information storage 108, and delivery schedule information storage 109. The information stored in these databases in an example embodiment is described above. As described above, the item delivery system of an example embodiment can also provide a physical storage area 102 for storage of tangible items until their delivery dates become current.

FIGS. 4 through 9 illustrate example user interface screen snapshots of example embodiments. These sample user interface sequences illustrate various features, structures, and operations of various example embodiments. Each of the user interface screens shown in FIGS. 4 through 9 are described above in an example embodiment.

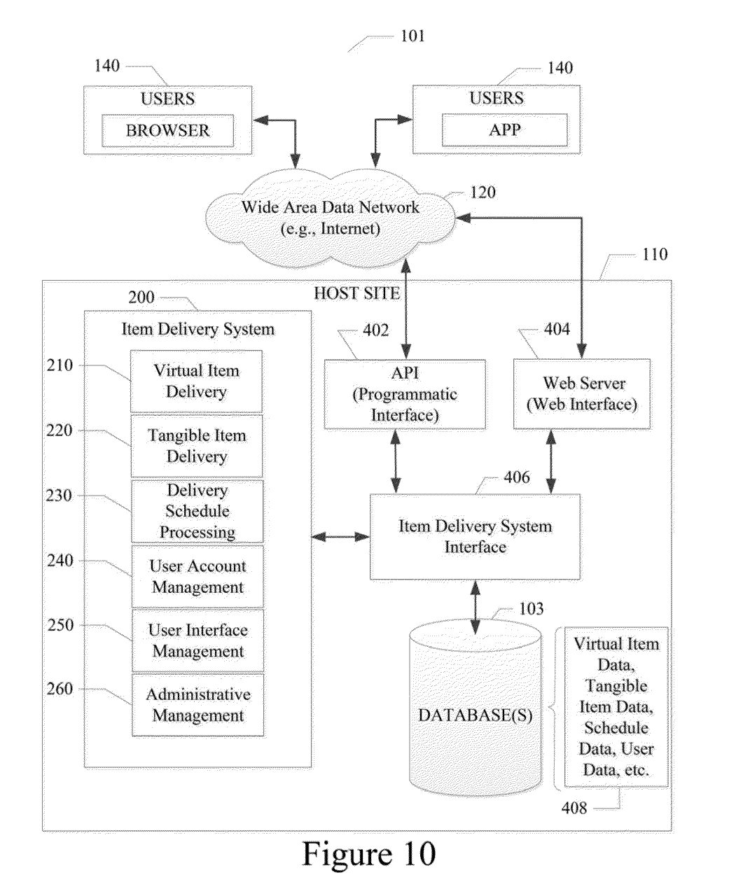

Referring now to FIG. 10, another example embodiment 101 of a networked system in which various embodiments may operate is illustrated. In the embodiment illustrated, the host site 110 is shown to include the item delivery system 200. The item delivery system 200 is shown to include the functional components 210-260, as described above. In a particular embodiment, the host site 110 may also include a web server 404, having a web interface with which users may interact with the host site 110 via a user interface or web interface. The host site 110 may also include an application programming interface (API) 402 with which the host site 110 may interact with other network entities on a programmatic or automated data transfer level. The API 402 and web interface 404 may be configured to interact with the item delivery system 200 either directly or via an interface 406. The item delivery system 200 may be configured to access a data storage device 103 and data 408 therein either directly or via the interface 406.

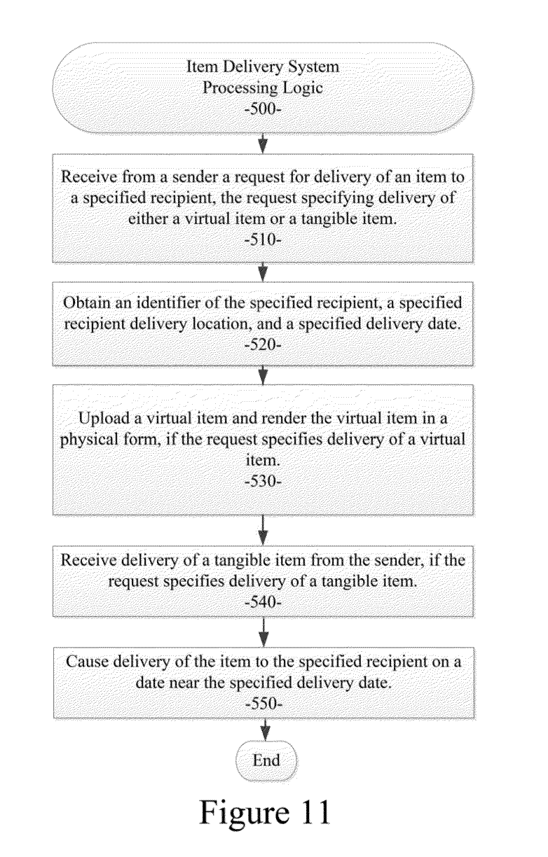

Referring now to FIG. 11, a processing flow diagram illustrates an example embodiment of an item delivery system 200 as described herein. The method 500 of an example embodiment includes: receiving from a sender a request for delivery of an item to a specified recipient, the request specifying, delivery of either a virtual item or a tangible item (processing block 510); obtaining an identifier of the specified recipient, a specified recipient delivery location, and a specified delivery date (processing block 520); uploading, by use of a data processor, a virtual item and rendering the virtual item in a physical form, if the request specifies delivery of a virtual item (processing block 530); receiving delivery of a tangible item from the sender, if the request specifies delivery of a tangible item (processing block 540); and causing delivery of the item to the specified recipient on a date near the specified delivery date (processing block 550).

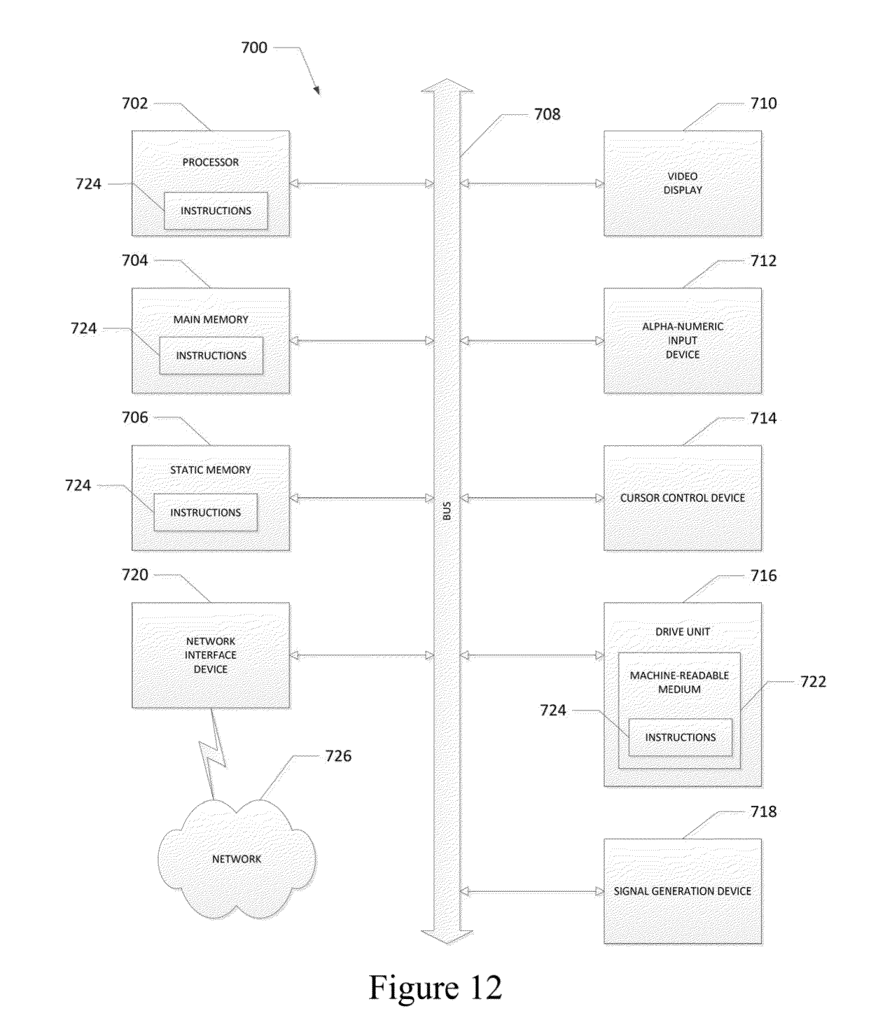

FIG. 12 shows a diagrammatic representation of a machine in the example firm of a computer system 700 within which a set of instructions when executed may cause the machine to perform any one or more of the methodologies discussed herein. In alternative embodiments, the machine operates as a standalone device or may be connected (e,g., networked) to other machines. In a networked deployment, the machine may operate in the capacity of a server or a client mad me in server-c 1a 3t network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” can also be taken to include any collection of machines that individually or jointly execute a set (or multiple sets) of instructions to perform any one or more of the methodologies discussed herein.

The example computer system 700 includes a processor 702 (e.g., a central processing unit (CPU), a graphics processing unit (GPU), or both), a main memory 704 and a static memory 706, which communicate with each other via a bus 708. The computer system 700 may further include a video display unit 710 (e,g., a liquid crystal display (LCD) or a cathode ray tube (CRT)). The computer system 700 also includes an input device 712 (e.g., a keyboard), a cursor control device 714 (e.g., a mouse), a disk drive unit 16, a signal generation device 718 (e.g., a speaker) and a network interface device 720.

The disk drive unit 716 includes a machine-readable medium 724 on which is stored care or more sets it instructions (e.g., software 724) embodying any one or more of the methodologies or functions described herein. The instructions 724 may also reside, completely or at least partially, within the main memory 704, the static memory 706, and/or within the processor 702 during execution thereof by the computer system 700. The main memory 704 and the processor 702 also may constitute machine-readable media. The instructions 724 may further be transmitted or received over a network 726 via the network interface device 720. While the machine-readable medium is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” can also be taken to include any medium that is capable of storing, encoding or carrying a set of instructions for execution by the machine and that cause the machine to perform any one or more of the methodologies of the various embodiments, or that is capable of storing encoding or carrying data structures utilized or associated with such a set of instructions. The term “machine-readable medium” can accordingly be taken to include, but not be limited to, solid-state memories, optical media, and magnetic media.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A computer-implemented method comprising:
receiving from a sender a request for delivery of an item to a specified recipient, the request specifying delivery of either a virtual item or a tangible item;
obtaining an identifier of the specified recipient, a specified recipient deliver location, and a specified delivery date;
uploading, by use of a data processor, a virtual item and rendering the virtual item in a physical form, if the request specifies delivery of a virtual item;
receiving delivery of a tangible item from the sender, if the request specifies delivery of a tangible item; and
causing delivery of the item to the specified recipient on a date near the specified delivery date.

2. The method as claimed in claim 1 wherein, the virtual item is from the group: an electronic document, a template letter, and a media item.

3. The method as claimed in claim 1 wherein the request is received at a website from a networked user at a user platform.

4. The method as claimed in claim 1 wherein the request is received from a mobile device of a networked user at a user platform.

5. The method as claimed in claim 1 including enabling a user to choose from among a plurality of various types of virtual items.

6. The method as claimed in claim 1 including enabling a user to choose from among a plurality of various types of template letters.

7. The method as claimed in claim 1wherein rendering the virtual item in a physical form includes printing a letter or a document.

8. The method as claimed in claim 1 wherein rendering the virtual item in a physical form includes burning a media item to an optical, magnetic, or semiconductor medium,

9. The method as claimed in claim 1including causing the item to be delivered using a standard mail or shipping carrier.

10. A system comprising:
a data processor;
a database, in data communication with the data processor, for storage of item data including an identifier of a specified recipient and a specified delivery date; and
an item delivery system, executable by the data processor, to:
receive from a sender a request for delivery of an item to the specified recipient, the request specifying delivery of either a virtual item or a tangible item;
obtain the identifier of the specified recipient, a specified recipient delivery location, and the specified delivery date;
upload a virtual item and render the virtual item in a physical form, if the request specifies delivery of a virtual item;
receive delivery of a tangible item from the sender, if the request specifies delivery of a tangible item; and
cause delivery of the item to the specified recipient on a date near the specified delivery date.

11. The system as claimed in claim 10 wherein the virtual item is from the an electronic document, a template letter, and a media item.

12. The system as claimed in claim 10 wherein the request is received at a website from a networked user at a user platform.

13. The system as claimed in claim 10 wherein the request is received from a mobile device of a networked user at a user platform,

14. The system as claimed in claim 10 being further configured to enable a user to choose from among a plurality of various types of virtual items.

15. The system as claimed in claim 10 being further configured to enable a user to choose from among a plurality of various types of template letters.

16. The system as claimed in claim 10 wherein rendering the virtual item in a physical form includes printing a letter or a document.

17. The system as claimed in claim 10 wherein rendering the virtual item in a physical form includes burning a media item to an optical, magnetic, or semiconductor medium.

18. The system as claimed in claim 10 being further configured to cause the item to be delivered using a standard mail or shipping carrier.

19. A non-transitory machine-useable storage medium embodying instructions which, when executed by a machine, cause the machine to
receive tram a sender a request for delivery of an item to a specified recipient, the request specifying delivery of either a virtual item or a tangible item;
obtain an identifier of the specified recipient, a specified recipient delivery location, and a specified delivery date;
upload a virtual item and rendering the virtual item in a physical form, if the request specifies delivery of a virtual item;
receive delivery of a tangible item from the sender, if the request specifies delivery of a tangible item; and
cause delivery of the item to the specified recipient on a date near the specified delivery date.

20. The non-transitory machine-useable storage medium as claimed in claim 19 wherein the virtual item is from the group: an electronic document, a template letter, and a media item.
